(19) United States
(12) Patent Application Publication
(10) Pub. No.: US 2015/0138412 A1
(43) Pub. Date: May 21, 2015

(54) IMAGE SENSORS AND SYSTEMS WITH AN IMPROVED RESOLUTION

(71) Applicant: Samsung Electronics Co., Ltd., Suwon-si (KR)

(72) Inventors: Ilia OVSIANNIKOV, Studio City, CA (US); Lilong SHI, Pasadena, CA (US); Myungwon LEE, Pusan (KR); Sangchul SUL, Suwon-City (KR); Gwideok LEE, Suwon-si (KR)

(73) Assignee: Samsung Electronics Co., Ltd., Suwon-si (KR)

(21) Appl. No.: 14/086,965

(22) Filed: Nov. 21, 2013

(51) Int. Cl. H04N 5/378

(52) U.S. Cl. CPC H04N 5/378
USPC 348/302

(57) ABSTRACT

A device, comprising a plurality of pixel arrays. Two or more pixel arrays are stacked in overlapping fashion and rotated. Optionally, one or more of the pixel arrays are shifted with respect to others. As a result, the horizontal and vertical Nyquist spatial sampling frequency limits are increased, thus permitting an increase in image resolution, for example in terms of line pairs that can be resolved, without reducing the pixel size. Certain stacked pixel pattern arrangement can also be read out as Bayer color pattern for processing by traditional Bayer image signal processors.

### BACKGROUND

This disclosure relates to image sensors and, in particular, to image sensors with improved resolutions.

Image sensors may be realized having a red pixel, a blue pixel, and two green pixels. These pixels are disposed such that in a row or column green pixels alternate with red pixels and in an adjacent row or column green pixels alternate with blue pixels. Using such an array of pixels, the pixel array may resolve between black and white lines that have a width equivalent to 1 pixel width.

To improve a resolution of an imaging device, the image sensor may be made with a higher number of pixels. However, below a particular width, the cost and difficulty of manufacturing such a pixel increases substantially.

### SUMMARY

An embodiment includes a device, comprising a plurality of pixel arrays. A first pixel array of the plurality of pixel arrays overlaps at least a part of the other pixel arrays; pixels of the pixel arrays are each disposed in rows extending in a first direction rotated relative to an axis; and the pixel arrays are configured to output a pattern including a third plurality of rows of elements extending in a second direction substantially parallel to the axis with each element of the pattern corresponding to a pixel of the pixel arrays.

An embodiment includes a device comprising: a first pixel array having alternating pixel types; and a second pixel array overlapping the first pixel array. The pixels of the first pixel array having a first type have a first pixel pitch. The pixels of the second pixel array have a second pixel pitch. The first pixel pitch is greater than the second pixel pitch.

An embodiment includes a device comprising a first pixel array having pixels of a first type; a second pixel array having pixels of a second type, the second pixel array overlapping the first pixel array; and a third pixel array overlapping the first and second pixel arrays. Centers of pixels of the first pixel array substantially overlap centers of pixels of the second pixel array; and centers of pixels of the third pixel array are substantially offset from the centers of the pixels of the first and second pixel arrays.

An embodiment includes a method, comprising: sensing light with a plurality of pixel arrays wherein a first pixel array of the pixel arrays overlaps at least one other pixel array of the pixel arrays; and outputting a pattern including a plurality of rows of elements extending in a first direction substantially parallel to an axis with each element of the pattern corresponding to a pixel of the first and second pixel arrays. Pixels of the pixel arrays are disposed in rows extending in a second direction rotated relative to the axis.

### BRIEF DESCRIPTION OF SEVERAL VIEWS OF THE DRAWINGS

FIG. 1 is a schematic view of pixel arrays according to an embodiment of the invention.

FIG. 2 is a schematic view of pixel pitches in pixel arrays according to an embodiment of the invention.

FIG. 3 is a schematic view of pixel pitches in pixel arrays according to an embodiment of the invention.

FIG. 4 is a schematic view of pixels in pixel arrays according to an embodiment of the invention.

FIG. 5 illustrates a maximum possible horizontal resolution in terms of Nyquist spatial frequency limit according to an embodiment.

FIG. 6 is a schematic view of a pixel array illustrating a resolving power of pixel arrays according to an embodiment of the invention.

FIG. 7 is a schematic view of a pixel array illustrating a resolving power of pixel arrays according to an embodiment of the invention.

FIG. 8 is a schematic view of a Bayer pattern generated from pixel arrays according to an embodiment of the invention.

FIG. 9 is a schematic view of an electronic system in which the image sensor can be used according to an embodiment.

FIG. 10 is a schematic view of an electronic system in which the image sensor can be used according to another embodiment.

### DETAILED DESCRIPTION

The embodiments relate to image sensors and devices and systems using such image sensors. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations.

However, the methods and systems will operate effectively in other implementations. Phrases such as “exemplary embodiment”, “one embodiment” and “another embodiment” may refer to the same or different embodiments as well as to multiple embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments are described in the context of image sensors having certain components. One of ordinary skill in the art will readily recognize that the present invention is consistent with the use of image sensors and systems having other and/or additional components and/or other features not inconsistent with the present invention. The methods and systems are also described in the context of single imaging pixels. However, one of ordinary skill in the art will readily recognize that the methods and systems are consistent with the use of multiple imaging pixels.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. Furthermore, in those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

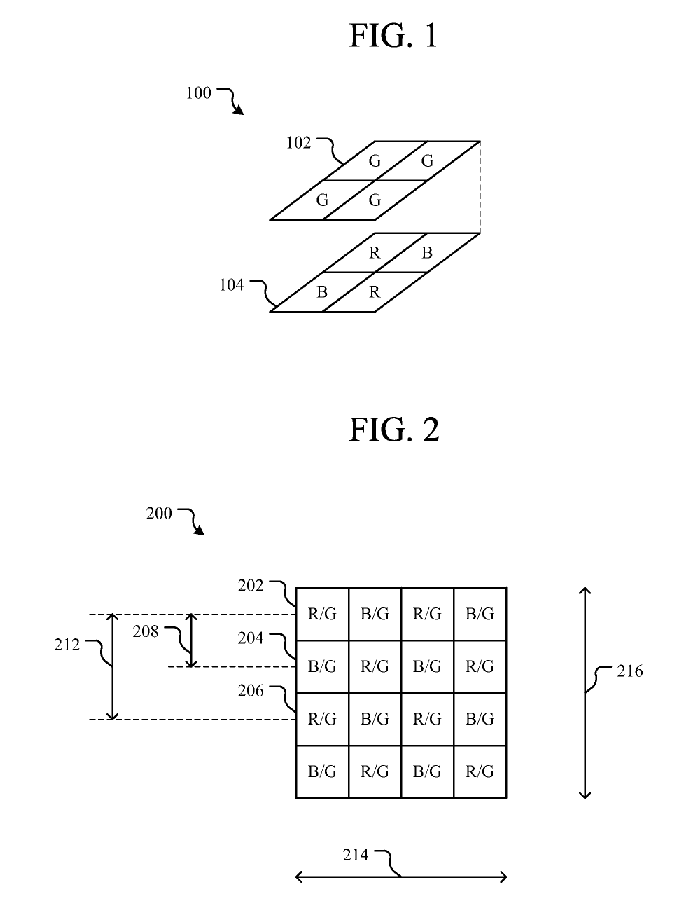

FIG. 1 is a schematic view of pixel arrays according to an embodiment of the invention. In this embodiment, the image sensor 100 includes a first pixel array 104 having alternating pixel types, and a second pixel array 102 overlapping the first pixel array 104. Here, the alternating pixel types of the first pixel array 104 are alternating red pixels and blue pixels. The second pixel array 102 includes green pixels. In this embodiment, the green pixels are substantially aligned with the red and blue pixels; however, as will be described in further detail below, in other embodiments, the green pixels may be offset from the red and blue pixels in a plane of the second pixel array 102.

Although green pixels are illustrated as above the red and blue pixels, in other embodiments, the pixels may be aligned as desired. For example, the green pixels may be disposed below the red and blue pixels. In another example, the green pixels may be above the red pixels and below the blue pixels, or vice versa.

The pixels of the pixel arrays 102 and 104 may be any variety of pixels configurable to sense light. In other embodiments, the pixels may include organic semiconductor pixels; however, any pixel that may operate in an overlapping or stacked configuration may be used. For example, in an embodiment, the pixel array 102 may include one or more organic layers forming green pixels of the pixel array 102. The pixel array 104 may include one or more semiconductor layers forming semiconductor pixels of the pixel array 104. Although the pixels of the pixel array 102 have been used as examples of pixels formed from organic layers, the pixels of the pixel arrays 102 and 104 may be formed from any combination of organic pixels, semiconductor pixels, or other types of pixels.

In an embodiment, layers of the pixel arrays 102 and 104 may be ordered depending on the relative absorption and/or relative conversion efficiency of the layers, electrodes, pixels, or the like. Layers of the pixels may be arranged in an order corresponding to the wavelength of the corresponding pixels. Layers for pixels associated with wavelengths with lower absorption may be placed closer to a top surface of an image sensor 100 than layers for pixels associated with wavelengths with higher absorption. In another example, stacked pixels may rely upon the natural wavelength-dependent absorption properties of silicon which provides inherent filtering in the visible band. Silicon-based image sensors may have three stacked photodiodes per pixel location to provide full-color imaging without external color filters. In stacked pixels, each pixel consists of more than one vertically stacked photodiode. Each photodiode responds to different wavelengths of light, i.e., each has a different spectral sensitivity curve, to capture signals from different color channels, such as red, green, blue, or the like. For example, the diode nearest the surface absorbs mostly blue light and the deeper diode absorbs mostly red light. Organic pixels and/or other pixel types may be similarly disposed, based on wavelength-dependent absorption. In other embodiments, different pixel types may have different characteristics and may be disposed in different orders to increase efficiency.

FIG. 2 is a schematic view of pixel pitches of pixels of pixel arrays according to an embodiment of the invention. Image sensor 200 may be formed similar to image sensor 100. Referring to FIGS. 1 and 2, the image sensor 200 is illustrated in a plan view where “R/G” represents a green pixel overlapping a red pixel and “B/G” represents a green pixel overlapping a blue pixel.

In rows 202, 204, and 206 extending along direction 214, red pixels alternate with blue pixels. However, the pixels of row 204 are offset from those of rows 202 and 206 such that the columns extending along direction 216 of the image sensor 200 also alternate red pixels with blue pixels. As a result, the red pixels have a pixel pitch 212. Here the pixel pitch 212 is about 2 pixel widths. The pixel pitch 208 between red and blue pixels is about 1 pixel width. The green pixels also have a pixel pitch 208 of about 1 pixel width. Accordingly, the pixel pitch of pixels of the same type, i.e. red pixels or blue pixels, is greater than the pixel pitch of the green pixels.

Although the red pixels and blue pixels have been described as alternating in both rows and columns, in another embodiment, the red pixels and blue pixels may alternate differently. For example, the red and blue pixels may alternate only in the direction 214. That is, the image sensor 200 may have lines of red pixels alternating with lines of blue pixels.

In an embodiment, directions 214 and 216 are substantially perpendicular. However, in other embodiments, directions 214 and 216 may not be perpendicular.

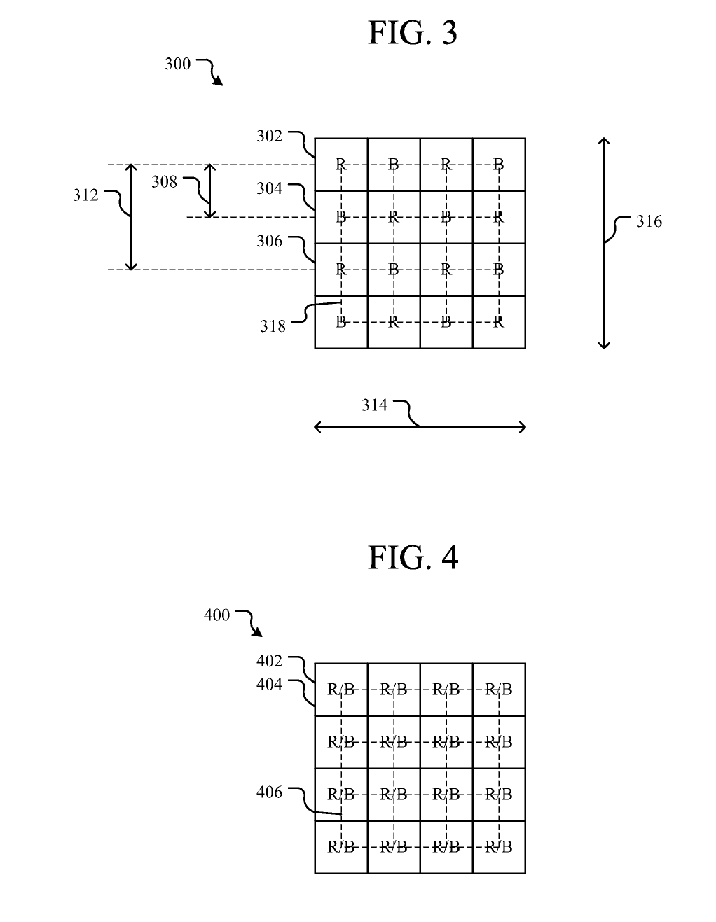

FIG. 3 is a schematic view of pixel pitches of pixels of pixel arrays according to an embodiment of the invention. In an embodiment, the image sensor 300 includes green pixels 318 offset from the red and blue pixels in a plane of the pixel array. For example, the green pixels 318 are offset in both directions 314 and 316. Here, perimeters of the green pixels 318 are illustrated by dashed lines without an associated “G”. The red and blue pixels are illustrated with letters “R” and “B”.

Pixel pitches 308 and 312 are similar to pixel pitches 208 and 212 described above. That is, the pixel to pixel pitch of the red and blue pixels is pixel pitch 308 while the pixel pitch between pixels of the same type is the pixel pitch 312. The green pixels also have the pixel pitch 308. However, here, the pixel pitch 308 is measured from edges of the green pixels 318 rather than the centers as illustrated in FIG. 2.

FIG. 4 is a schematic view of pixels of pixel arrays according to an embodiment of the invention. In this embodiment, the image sensor 400 includes pixel arrays 402, 404, and 406. Pixel array 402 includes red pixels and pixel array 404 includes blue pixels. The pixel arrays 402 and 404 overlap and are substantially aligned. Accordingly, overlapping red and blue pixels are labeled “RIB”.

Pixel array 406 includes green pixels illustrated by the dashed lines. The pixel array 406 overlaps the pixel arrays 402 and 404. However, the pixels of the pixel array 406 are substantially offset from the corresponding pixels of the pixel arrays 402 and 404. For example, the pixels of the pixel array 406 may be offset similar to the green pixels 318 described above with respect to FIG. 3.

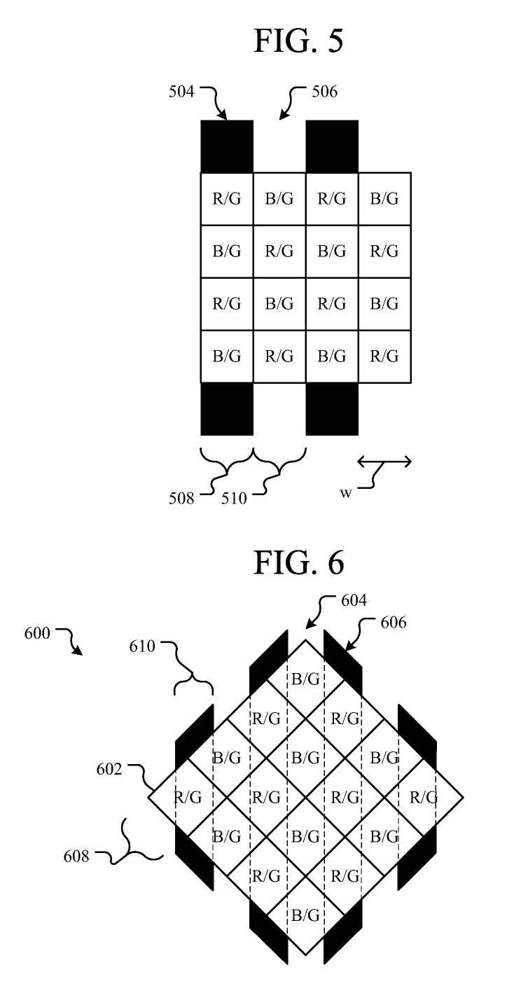

FIG. 5 illustrates a maximum possible horizontal resolution in terms of Nyquist spatial frequency limit according to an embodiment. Each of the alternating black and white lines 504 and 506 are imaged by its own column of green pixels 508 and 510, respectively. The width of a green pixel, as well as its pitch, is equal to w. Therefore the minimum line width that can be resolved considering the Nyquist frequency limit is w, equal to one line per pixel pitch w.

FIG. 6 is a schematic view of a pixel array illustrating a resolving power of pixel arrays according to an embodiment of the invention. To illustrate the resolving power, alternating white lines 604 and black lines 606 are illustrated. The lines 604 and 606 incident on the pixel array 600 are illustrated in phantom for clarity.

In an embodiment, the pixel array 600 may resolve between white line 604 and black line 606 as the lines 604 and 606 are incident on different sets of green pixels 602. That is, the while line 604 is incident on one vertical set of green pixels 602 while the black line 606 is incident on an adjacent vertical set of green pixels 602. A relative resolvable line width or height 610 of the lines 604 and 606 is given by equation 1, where w is a width or height of a pixel row 608.

$$Resolvable Line Width or Height = \frac{w}{\sqrt{2}} \qquad ( 1 )$$

As the effective improvement in the maximum number of line pairs that may be resolved in one direction increases by V, the effective improvement in the maximum number of line pairs that may be resolved by pixel array 600 in both vertical and horizontal increases by a factor of \sqrt{2}. That is, without changing the size of the pixels, the effective spatial density of sampling locations in the same area is increased by a factor of 2. Accordingly, a resolving power of a pixel array in terms of spatial Nyquist frequency can be increased without reducing a pixel size, a pixel array with larger pixels may be used.

Although a pixel in an array with an aspect ratio of 1 has been used as an example, the aspect ratio of a pixel in an array may be different. As a result, an improvement in the resolving power of the pixel array 600 may be greater or less than 2.

At the illustrated line width of lines 604 and 606, are incident on each green pixel 602 in some amount. The ratio of black to white on each pixel 602 may be either about 1:3 or about 3:1. Accordingly, when resolving lines at this resolution, a maximum value may be decreased and a minimum value may be increased, or in other words contrast reproduction and the magnitude of the modulation transfer function value at higher frequencies may decrease.

In an embodiment, the absence of decrease in pixel area while obtaining a higher spatial sampling density may improve the signal to noise ratio compared to obtaining same density via pixel size shrink. As the effective noise may be reduced, an additional amount of sharpening may be performed to compensate the decrease in contrast. Sharpening may introduce additional noise, however the additional noise may be tolerated to some extent due to the increased signal-to-noise ratio. This additional sharpening may result in an improved image quality. Thus, an impact of the mixing of adjacent lines described above may be alleviated.

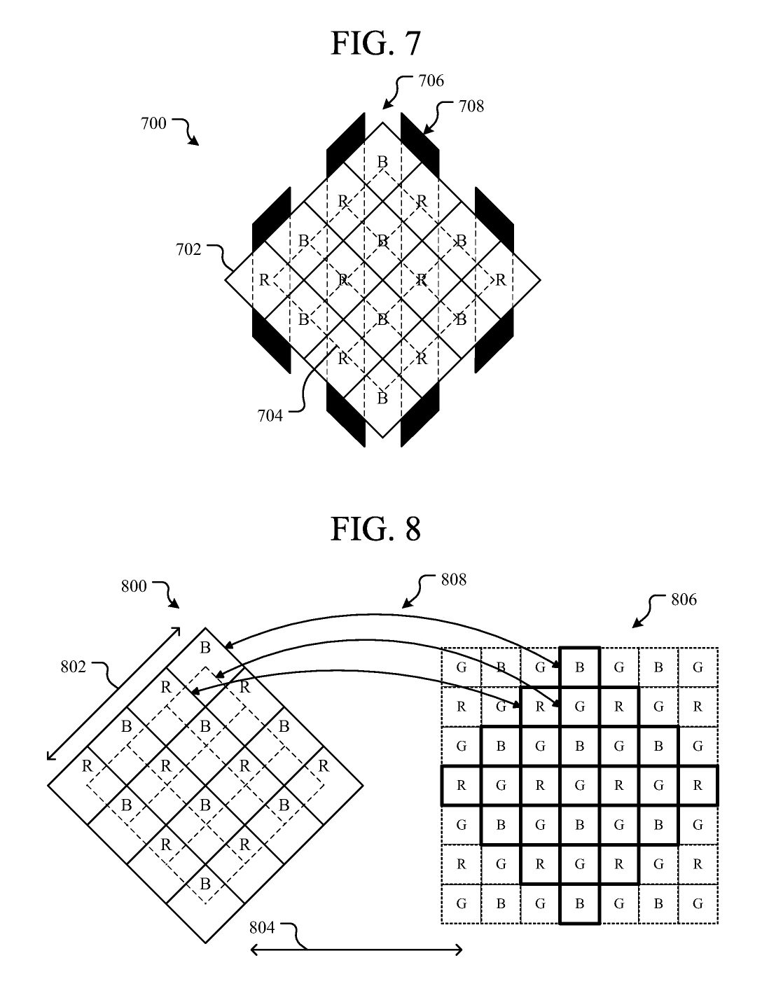

FIG. 7 is a schematic view of a pixel array illustrating a resolving power of pixel arrays according to a preferred embodiment of the invention. In this embodiment, the image sensor 700 is similar to the image sensor 300 of FIG. 3 where the green pixel array is shifted with respect to the red-and-blue array by half pixel pitch both vertically and horizontally, followed by rotation by 45 degrees. The white lines 706 and black lines 708 are incident on different sets of green pixels 704 similar to FIG. 6. Thus, even though the green pixels 704 are offset relative to the green pixels of FIG. 6, the image sensor 700 may have a similar resolving power.

In this embodiment, the centers of the green pixels 318 are substantially equidistant from centers of adjacent red and blue pixels. The centers may be the geometric centers, the effective center for incident light, or the like.

FIG. 8 is a schematic view of a Bayer pattern generated from pixels of pixel arrays according to an embodiment of the invention. In this embodiment, image sensor 800 is similar to image sensor 300 described above. Rows of the image sensor 800 extend in substantially direction 802. Although the term row is used, the corresponding series of pixels may also be referred to as a column depending on orientation. Accordingly, as used herein, a row represents a series of pixels extending in one direction, regardless of that direction.

The direction 802 is rotated relative to the axis 804. In an embodiment, the axis 804 is an axis of a pattern 806. In an embodiment, the axis 804 may be aligned with a physical structure of a device, such as a camera or other imaging device. However, in other embodiments the axis 804 may be independent of such structures.

The pattern 806 includes rows of elements extending in a direction substantially parallel to the axis 804. Each element of the pattern corresponds to a pixel of the pixel arrays of the image sensor 800. For example, arrows 808 illustrate the relationship between a red pixel, a blue pixel, and a green pixel of the image sensor 800 and corresponding red, blue, and green elements of the pattern 806. The illustrated pixels of the image sensor 800 correspond to the elements of the pattern 806 with solid lines. Elements illustrated with dashed lines represent elements of the pattern that correspond to pixels of the image sensor 800 that may extend beyond the illustrated pixels. These elements are illustrated to show that in an embodiment, the pattern may be a substantially rectangular pattern.

In an embodiment, the pixel arrays of the image sensor 800 are configured to output the pattern 806. That is, the pixel arrays may not be configured to output a pattern that has rows aligned with rows of the pixel arrays, but rather aligned in a different, rotated direction.

In this embodiment, the direction 802 of the rows of the image sensor 800 is rotated about 45 degrees relative to the axis 804. Accordingly, the rows of the elements of the pattern 806 are rotated about 45 degrees relative to the rows of the image sensor 800. A result of the rotation and the layout of the pixels of the image sensor 800, the resulting pattern 806 is a Bayer pattern. In other words, even though the pixels themselves are not disposed in a Bayer pattern, a Bayer pattern may be output from the pixels. In this embodiment, the individual pixel outputs map directly to corresponding elements of the pattern 806. Accordingly, the pixel outputs may be directly used as a Bayer pattern without further processing. As a result, downstream processing of an image may, but need not change from existing Bayer pattern processing. That is, an image sensor of an existing imaging device that is configured to process a Bayer pattern output from the image sensor may be replaced with an image sensor as described herein without change to the pattern processing, yet still achieve a greater resolution.

As will be described in further detail below, a controller may be coupled to the image sensor 800. The controller may be configured to select pixels of the image sensor 800 to be read. The controller may be configured to select pixels that correspond to rows of the pattern 806. Accordingly, pixels of the rows of the image sensor 800 extending substantially in direction 802 may be read out at different times as they correspond to different rows of the pattern 806.

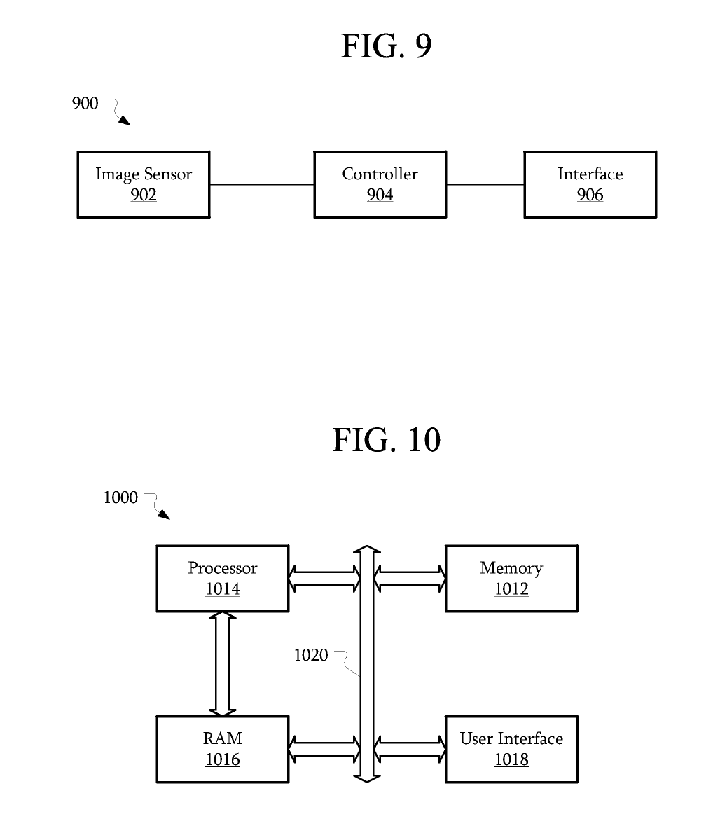

FIG. 9 is a schematic view of an electronic system in which the image sensor can be used according to an embodiment. The system 900 includes an image sensor 902, a controller 904, and an interface 906. The system 900 may be a wide variety of electronic systems, such as an imaging device used in a portable computer, mobile telecommunication device, a computer peripheral, or any other device that may be interfaced with an imaging device. The image sensor 902 may be an image sensor as described above.

The controller 904 is coupled to the image sensor 902. The controller 904 may be configured to generate an image in response to the image sensor 902. For example, the controller 904 may be configured to sense light using the pixels of the image sensor 902, process the sensed signals, and generate the image. In another example, the controller 904 may be configured to output a Bayer pattern in response to the image sensor 902. In an embodiment, the controller 904 may be configured to output a Bayer pattern that is rotated about 45 degrees from the image sensor 902.

The interface 906 is coupled to the controller 904. The interface 906 may be any interface that is capable of communicating data from raw pixel information processed image data. For example, the interface 906 may be a standardized interface such as a Universal Serial Bus (USB) interface, an Institute of Electrical and Electronics Engineers (IEEE) 1394 interface, or the like. In another example, the interface may be a non-standard, customized, or proprietary interface. In an embodiment, the interface 906 may be part of the controller 904.

FIG. 10 is a schematic view of an electronic system in which the image sensor can be used according to an embodiment. The electronic system 1000 may be used for a wide variety of electronic devices including imaging devices such as a computer or camera including, but not limited to, a portable notebook computer, Ultra-Mobile PCs (UMPC), Tablet PCs, a server, workstation, a mobile telecommunication device, satellite, set top box, TV and so on. For example, the electronic system 1000 may include a memory system 1012, a processor 1014, RAM 1016, and a user interface 1018, which may execute data communication using a bus 1020. The user interface 1018 may include imaging devices such as those described above.

The processor 1014 may be a microprocessor or a mobile processor (AP). The processor 1014 may have a processor core (not illustrated) that can include a floating point unit (FPU), an arithmetic logic unit (ALU), a graphics processing unit (GPU), and a digital signal processing core (DSP Core), or any combinations thereof. The processor 1014 may execute the program and control the electronic system 1000.

The RAM 1016 may be used as an operation memory of the processor 1014. Alternatively, the processor 1014 and the RAM 1016 may be packaged in a single package body.

The user interface 1018 may be used in inputting/outputting data to/from the electronic system 1000. For example, the user interface 1018 may include an imaging device as described above in a camera or other imaging device.

The memory system 1012 may store codes for operating the processor 1014, data processed by the processor 1014, or externally input data. The memory system 1012 may include a controller and a memory.

Although red, blue, and green pixels have been used as an example, pixels for different colors may be used. For example, in an embodiment, the green pixels may be replaced with pixels configured to sense a luminance related aspect of the light. The red and blue pixels may be replaced with corresponding other pixels to complement the luminance pixel.

Although particular shapes, pitches, positions, or the like of pixels have been described above, other shapes, pitches, positions, or the like of pixels may be used. For example, in an embodiment, the shapes of the pixels may be rectangular, circular, polygonal, irregular, or the like. The shapes of each pixel need not be identical. For example, green pixels may have a first shape and other pixels may have a second, different shape. In another embodiment, the pitches of the pixels need not be substantially uniform. For example, the pitch of the pixels in one direction may be different than the pitch of the pixels in a substantially orthogonal direction.

Although green pixels have been described above as being aligned to associated red and/or blue pixel and described as offset from red and/or blue pixels by a substantially uniform amount, the pixels may be offset in other ways. For example, the green pixels may be aligned to red and/or blue pixels in one direction and offset from the red and/or blue pixels in another direction.

Reference throughout this specification to “one embodiment” or “an embodiment” means that a particular feature, structure, or characteristic described in connection with the embodiment is included in at least one embodiment of the present invention.

Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Although the structures, methods, and systems have been described in accordance with exemplary embodiments, one of ordinary skill in the art will readily recognize that many variations to the disclosed embodiments are possible, and any variations should therefore be considered to be within the spirit and scope of the apparatus, method, and system disclosed herein. Accordingly, many modifications may be made by one of ordinary skill in the art without departing from the spirit and scope of the appended claims.

1. A device, comprising:
a plurality of pixel arrays;
wherein:
a first pixel array of the plurality of pixel arrays overlaps at least a part of the other pixel arrays;
pixels of the pixel arrays are each disposed in rows extending in a first direction rotated relative to an axis; and
the pixel arrays are configured to output a pattern including a third plurality of rows of elements extending in a second direction substantially parallel to the axis with each element of the pattern corresponding to a pixel of the pixel arrays.

2. The device of claim 1, wherein the pattern is a Bayer pattern.

3. The device of claim 1, wherein the first direction is rotated by about 45 degrees relative to the axis.

4. The device of claim 1, wherein:
the first pixel array includes green pixels; and
a second pixel array of the pixel arrays includes red and blue pixels.

5. The device of claim 4, wherein the red and blue pixels alternate in a row of the second pixel array.

6. The device of claim 1, wherein:
pixels of the first pixel array are offset from pixels of the other pixel arrays in a plane of the first pixel array.

7. The device of claim 1, wherein for at least one pixel of the first pixel array, a center of the pixel of the first pixel array is substantially equidistant from centers of pixels of the other pixel arrays overlapping the pixel of the first pixel array.

8. The device of claim 1, further comprising:
a controller; and
user interface coupled to the controller;
wherein the controller is configured to generate an image in response to the pattern.

9. The device of claim 1, wherein at least one of the pixel arrays comprises organic pixels.

10. The device of claim 1, wherein the pattern has a higher Nyquist spatial frequency than a pattern from a pixel array disposed in a Bayer pattern.

11. A device, comprising:
a first pixel array having alternating pixel types; and
a second pixel array overlapping the first pixel array;
wherein:
pixels of the first pixel array having a first type have a first pixel pitch;
pixels of the second pixel array have a second pixel pitch; and
the first pixel pitch is greater than the second pixel pitch.

12. The device of claim 11, wherein:
the pixels of the first type alternate with pixels of a second type in a first direction in the first pixel array.

13. The device of claim 12, wherein
the pixels of the first type alternate with pixels of the second type in a second direction in the first pixel array; and
the first direction and the second direction are substantially perpendicular.

14. The device of claim 11, wherein:
centers of pixels of the second pixel array are substantially equidistant from centers of adjacent pixels of the first pixel array.

15. The device of claim 11, wherein:
the first pixel array comprises red and blue pixels; and
the second pixel array comprises green pixels.

16. A method, comprising:
sensing light with a plurality of pixel arrays wherein a first pixel array of the pixel arrays overlaps at least one other pixel array of the pixel arrays; and
outputting a pattern including a plurality of rows of elements extending in a first direction substantially parallel to an axis with each element of the pattern corresponding to a pixel of the first and second pixel arrays
wherein:
pixels of the pixel arrays are disposed in rows extending in a second direction rotated relative to the axis.

17. The method of claim 16, wherein the pattern is a Bayer pattern.

18. The method of claim 16, wherein second direction is rotated about 45 degrees relative to the axis.

19. The method of claim 16, further comprising selecting pixels of the pixel arrays across multiple rows of the pixel arrays to output a row of the pattern.

20. The method of claim 16, wherein the first pixel array comprises green pixels.

21. The method of claim 20, wherein the other pixel arrays comprise red and blue pixels.
